(19) United States
(12) Patent Application Publication
(10) Pub. No.: US 2026/0253481 A1
(43) Pub. Date: Aug. 27, 2026

(54) IN-VEHICLE DETECTION AND SAFETY ALARM SYSTEM

(71) Applicants: Lawrence L. SLUSSER, Temecula, CA (US); Daniel L. SLUSSER, Temecula, CA (US); Jacob A. SLUSSER, Temecula, CA (US); Jared A. SLUSSER, Temecula, CA (US)

(72) Inventors: Lawrence L. SLUSSER, Temecula, CA (US); Daniel L. SLUSSER, Temecula, CA (US); Jacob A. SLUSSER, Temecula, CA (US); Jared A. SLUSSER, Temecula, CA (US)

(21) Appl. No.: 19/547,304

(22) Filed: Feb. 23, 2026

Related U.S. Application Data
(60) Provisional application No. 63/762,553, filed on Feb. 24, 2025.

(51) Int. Cl. G08B 21/02; B60Q 5/00

(52) U.S. Cl. CPC G08B 21/0275; B60Q 5/005

(57) ABSTRACT

An in-vehicle system performs monitoring for an unattended occupant. The monitoring system can be a standalone device or integrated into the vehicle system. The monitoring system can trigger an emergency condition, such as triggering the horn, triggering the car alarm, or sending an alert to the vehicle operation, in response to detecting the unattended occupant.

### PRIORITY

This application is a nonprovisional based on, and which claims the benefit of priority of, U.S. Provisional Application No. 63/762,553, filed Feb. 24, 2025.

### TECHNICAL FIELD

Descriptions are generally related to vehicle security systems, and more particular descriptions are related to in-vehicle monitoring.

### BACKGROUND OF THE INVENTION

More people are trying to navigate competing responsibilities of earning income as well as taking care of children and caring for a household. The busier people become, the more they tend to try to multitask, often resulting in distraction while performing tasks. Busy adults are often accompanied by pets and young children as they run errands, go shopping, go to work, or travel to and from other activities.

The pets and children may become accustomed to the routine of being in the vehicle, either falling asleep or otherwise remaining quiet in the back seat. When the driver exits, a momentary lapse of focus on their pet or child can result in leaving an unattended occupant inside the vehicle. Tragically, numerous pets and even children die from heat exhaustion, dehydration, or exposure to cold when they are forgotten. It can only take a few minutes for a car to heat up on a warm day and a small child or pet to succumb to exhaustion and dehydration. Even cold weather can lead to death and traumatic harm to a family.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a vehicle with in-vehicle monitoring.

FIG. 2 is a block diagram of an example of a system to perform in-vehicle monitoring.

FIG. 3 is a block diagram of an example of a system for in-vehicle monitoring.

FIG. 4 is a block diagram of an example of an in-vehicle monitoring system that accesses identification chips.

FIG. 5 is a flow diagram of an example of a process for performing in-vehicle monitoring.

FIG. 6 is a flow diagram of an example of a process for performing in-vehicle sensing and monitoring.

FIG. 7 is a block diagram of an example of a computer system to perform in-vehicle monitoring.

Descriptions of certain details and implementations follow, including non-limiting descriptions of the figures, which may depict some or all examples, and well as other potential implementations.

### DETAILED DESCRIPTION OF THE INVENTION

As described herein, an in-vehicle monitoring device can detect specific conditions and trigger an alert in response to the specific conditions. More specifically, the monitoring device triggers the alert in response to conditions that indicate that an occupant has been left unattended in the vehicle. The alert can indicate to the driver/vehicle operator or an external observer that there is a condition that needs attention.

The in-vehicle monitoring device can be implemented in a system marketed as “Safe and Secure” (or “SAS”). It will be understood that the technology can be implemented in other systems under other naming or branding. Rather than refer to a potential product name, the descriptions herein will refer primarily to the “monitoring device,” referring to the in-vehicle monitoring device. It will be understood that the descriptions of the monitoring device refer to any monitoring device that operates as described herein.

The in-vehicle monitoring device can include hardware and firmware/software. In one example, the monitoring device is a standalone device that plugs into the vehicle control system, such as plugging into the vehicle's OBD (onboard diagnostic) port. As a standalone device, a processor on the device hardware can execute an operating system. In one example, the monitoring device can be integrated into the vehicle computer and sensor system. As a component integrated into the car, the operating system can be the vehicle management system, vehicle entertainment system, or other vehicle operating system, with the hardware acting as sensors for the operating system.

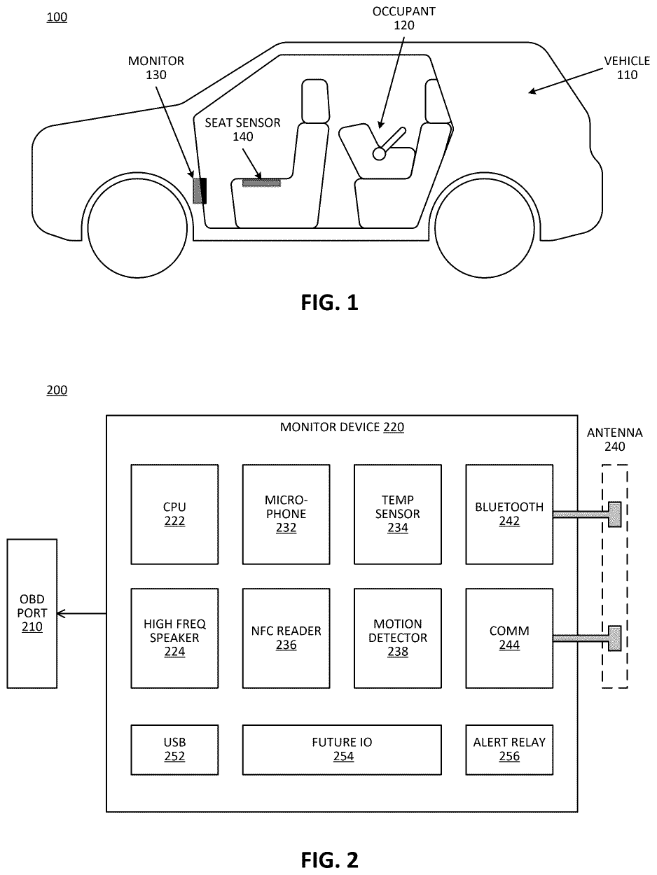

FIG. 1 is a block diagram of an example of a vehicle with in-vehicle monitoring. System 100 illustrates an automobile with an in-vehicle monitor device. Vehicle 110 represents the automobile with monitor 130. Monitor 130 represents a monitor device internal to vehicle 110, in accordance with any example herein.

Occupant 120 represents an unattended occupant in the back of vehicle 110, where occupant 120 is not capable of caring for themself if the operator/driver of the automobile leaves them unattended. In one example, occupant 120 represents a child. In one example, occupant 120 represents an animal/pet.

Monitor 130 provides a presence detector device in vehicle 110, which detects occupant 120 being left unattended, and can perform a remedial action to try to prevent occupant 120 from being left unattended. The remedial action can be any kind of alert or warning provided in response to detecting the unattended occupant.

In one example, vehicle 110 includes seat sensor 140. Seat sensor 140 represents a sensor that detects an operator of the vehicle. For example, seat sensor 140 can be a pressure sensor, a weight sensor, or other type of sensor that can detect someone sitting in the driver's seat. In one example, system 100 uses seat sensor 140 to determine if an operator is present in vehicle 110. In one example, system 100 uses a combination of seat sensor 140 and a wireless sensor for a key fob or a mobile device to determine if an operator is present in vehicle 110.

Examples of alerts can include existing mechanisms of vehicle 110 for sending alerts, such as the car horn or an alarm sound signal. Such alerts may be most effective if triggered when the vehicle operator is within earshot. An example sequence could make the use of a horn more effective, such as by initially honking the horn (e.g., 2 or 3 short honks in sequence) as the driver leaves the vehicle. If the system still detects the alert condition after the initial sequence of short honks, the system could trigger another burst of honks, for example, 3-5 seconds later. If the system still detects the condition after that alert, the system can trigger additional bursts, for example, spaced approximately 10-15 seconds apart, until the condition is resolved.

In addition to, or as an alternative to the use of the car horn, other alerts can include the use of cellular signals to alert the vehicle owner or operator, or to alert emergency services. In one example, the system can play a pre-recorded sound, such as a voice indicating that the vehicle has an unattended occupant.

In one example, monitor 130 includes multiple sensors powered by the car battery independent of the ignition being on. In one example, monitor 130 is integrated into the car infotainment system. In one example, monitor 130 is integrated into the car accessories. In one example, monitor 130 is integrated into car controls. In one example, monitor 130 is plugged into the vehicle's OBD (onboard diagnostic) port under the steering wheel column and has its own operating system. In one example, monitor 130 includes a sensor device plugged into the OBD port and is operated by the vehicle's software.

In one example, monitor 130 includes one or more sensors to detect RFID (radio frequency identification) chips. For example, the system can be programmed/configured to monitor specific RFIDs. In one example, a pet collar or a child car seat can have an RFID chip, which monitor 130 is programmed to recognize. If monitor 130 detects the RFID while the vehicle is not running and while there is no operator detected in the driver's seat and passenger seat, the device can determine there is an unsafe condition. In response to the unsafe condition, the device can trigger the vehicle to make an alert sound.

The detection of the RFID chip while not detecting an operator and determining that the vehicle is not operating represents the simultaneous occurrence of several conditions. Monitor 130 can be programmed to recognize many such occurrences of specific conditions as potentially unsafe situations. When the system determines that an unsafe situation is indicated, it can trigger an alert as indicated above.

FIG. 2 is a block diagram of an example of a system to perform in-vehicle monitoring. System 200 illustrates a monitoring system in accordance with an example of system 100. In one example, system 200 represents monitor 130 of system 100. System 200 can represent a standalone monitoring device plugged into the car infotainment system, or can represent an integrated monitoring system in the car infotainment system.

In one example of a standalone monitoring device implementation, monitor device 220 is plugged into OBD port 210 of the vehicle in which it is installed. Monitor device 220 includes various components, including sensors and communication components. In one example of an integrated monitoring device implementation, monitor device 220 is part of another vehicle system that has access to various sensors and communication components.

Monitor device 220 can be implemented in any number of possible configurations, with sensors, processors, antennas, speakers, interface components, or other features, or a combination. It will be understood that the various components and features can be different for different product implementations of system 200, thus, what is illustrated is not limiting in what components are included or left out of any specific implementation.

In one example, monitor device 220 includes a device package that has a board (e.g., a PCB (printed circuit board)) with microchips and electronic components mounted on the board. In one example, monitor device 220 is implemented as an IC (integrated circuit) device. In one example, monitor device 220 is implemented as an SBC (single board computer) device. By connecting monitor device 220 into OBD port 210, monitor device 220 can be powered by the car battery, regardless of the state of car ignition. Alternatively, monitor device 220 can include a battery component to power the device.

In one example, monitor device 220 includes CPU (central processing unit) 222. CPU 222 can represent a microprocessor or other controller that runs software to manage the sensors, receive and process sensor input data, make decisions on the data, and take action on the decisions. In one example, CPU 222 is part of a vehicle system instead of part of monitor device 220. In such an implementation, monitor device 220 can communicate the information to the CPU through OBD port 210 or through another interface port of the vehicle.

In one example, monitor device 220 includes one or more sensors, which provide inputs to the system to determine when an unsafe condition exists for an unattended occupant in a vehicle. In one example, monitor device 220 accesses one or more sensors, or data from one or more sensors. For example, monitor device 220 implemented as a device plugged into OBD port 210 could access sensors or sensor data through OBD port 210. The sensors in monitor device 220 can include, but are not limited to: microphone 232, temperature (temp) sensor 234, NFC (near field communication) reader 236, and motion detector 238.

Microphone 232 represents a sound monitor or microphone that can serve multiple purposes, such as listening for the cry of a child or the bark of a dog to determine if an unattended occupant is in the vehicle. Microphone 232 could listen for a human voice, indicating the driver is still present.

Temperature (temp) sensor 234 represents a temperature monitor for determining the interior temperature of the car. The system can determine whether the temperature has reached or is reaching threatening levels of hot (e.g., a high temperature threshold) or cold (e.g., a low temperature threshold). The temperature determination can be computed based on one or more threshold levels. For example, the system can determine if the monitored temperature has reached a threshold.

NFC (near field communication) reader 236 represents a sensor that reads communications. NFC reader 236 is capable of detecting “chipped” animals or bracelets worn by children, as well as the absence of a device, such as the owner's mobile phone. Chipped animals or chipped humans refers to configuring the monitoring system to recognize an RFID chip associated with a person or an animal. In one example, the system is configured with multiple IDs, representing different occupants (e.g., a child and a pet, multiple children) or different chips for an occupant (e.g., a collar and a carrier for a pet, a bracelet and a car seat ID for a child).

Motion detector 238 represents a sensor to determine if the car is moving or parked. In one example, monitor device 220 includes a GPS (global positioning satellite) device to determine the position of the device and car for alerting emergency services to its location. In one example, monitor device 220 does not include its own GPS device, but instead relies on GPS data from the car.

As mentioned above, CPU 222 can take action on determinations made from the input from sensor devices. The action can include triggering an alert. The triggering of an alert can be considered an output that system 200 generates in response to detecting an unsafe condition for an unattended occupant. Output/alert devices can include, but are not limited to: high frequency (freq) speaker 224, alert relay 256, and antenna 240. High-frequency speaker 224 enables system 200 with a noise generator that can be used to test for the presence of an animal or child by producing an uncomfortable sound. In one example, system 200 can detect the presence of a chip associated with an occupant to monitor, detects conditions indicative of an unsafe condition, but does not detect noise from the occupant. In such a case, the system can trigger the noise generator to prompt the occupant to make noise (e.g., a cry, a bark) to verify that the occupant is unattended in the vehicle.

Alert relay 256 represents a relay to an alert system, such as the car horn or an alarm system or other sound/alert signal generator. Triggering alert relay 256 can cause the car to make a sound to alert the driver leaving the car or bystanders of the detected condition. Antenna 240 represents a device that can enable monitor device 220 to send communication via an airwave channel, such as Bluetooth 242 or COMM (communication) 244.

Bluetooth 242 represents an optional wireless channel for sending alerts to a nearby mobile phone or for product setup. Bluetooth 242 could also be used to detect the presence or absence of a driver via their mobile device. It will be understood that since devices can be left behind, monitoring for the presence of a driver/operator via a mobile device is more reliable than monitoring for the absence of the driver/operator. In one example, determining if an operator is present can be performed for a stopped vehicle by both determining if a mobile device is outside the car and a seat pressure sensor indicates no one is present. COMM 244 can represent a cellular, LTE (long term evolution), GPS, or other wireless communication channel to send notifications to a mobile device or to emergency services.

While primarily indicated as an output device, in one example, antenna 240, through Bluetooth 242 or COMM 244, can act as an input device to receive information wirelessly. In one example, monitor device 220 can have one or more additional IO (input/output) devices. The IO devices can include USB (universal serial bus) 252, which can allow programming monitor device 220. Future IO 254 represents a future expansion interface, which can represent any type of IO that can be included to provide functionality to monitor device 220, whether to provide input or output.

In one example, with system 200 determining the absence of a driver and a backseat occupant, the software executed by CPU 222 can determine a dangerous situation. Some modern cars provide an alert on the driver dashboard when the weight of an object is detected in the backseat. However, the sensors in modern cars often trigger false positives by something as simple as a backpack, briefcase, or an empty car seat. An abundance of false positives inadvertently begins to desensitize drivers to potential problems. System 200 provides improved sensing of the conditions, which is expected to provide more reliable alerts to drivers.

System 200 can be built into every newly manufactured vehicle, either as a standard feature, or as an optional upgrade. Installation can also be aftermarket, with monitor devices having different levels of features and functions, with combinations of the features and functions described above. The basic level of the system can include detection of an unattended occupant in a vehicle that has stopped operating.

In one example, a trained mechanic can install a monitor device to an existing OBD port and powerlines of the car battery. In one example, the car owner can install the monitor device under the driver's dashboard. Depending on the feature set, the monitor device is automatically functional as soon as it is connected to power, providing monitoring functions. In one example, more advanced features may require setup. The setup can include configuration of the monitor device for chips or other wireless connections. In one example, configuration of the monitor device can be through a mobile app over wireless (e.g., Bluetooth, Wi-Fi, LTE) or through a wired connection to the monitor device (e.g., USB, OBD port).

Various implementations of the monitor device can have different feature sets, depending on market needs. Consider an example of the following variations:

A base model that includes only motion and NFC sensors with alarm/car horn integration. Such a model would be fairly basic in its ability to determine that a chipped pet or child is present in a car that is no longer in motion, and trigger the alarm/horn.

A more advanced model can include the features of the base model, as well as including interior and exterior temperature sensors, sound monitor, a high frequency noise generator, and Bluetooth would allow more advanced presence detection and logic to better avoid false positives. The more advanced model variant could be configured with a mobile app without requiring a chipped pet or chipped baby carrier, as the device would be able to rely on the microphone to listen for cries or barking. The high frequency noise generator would be able to prompt noise as a test of occupancy. Such an advanced model can avoid unnecessary alerts when the temperature is still in the safe zone. In one example, the system can alert the driver with a text message or SMS (short message service) message.

In one example, the high frequency noise generator refers to any high-pitch noise, which could be heard by humans or animals. In one example, the high frequency noise generator makes a high-pitch sound in a frequency range above human hearing, which would be detectable by animals.

An even more advanced model variant could include GPS and cellular/LTE connectivity. Such a variant can enable the system to notify the owner of a problem on their mobile device, far out of range of the car. In one example, the system could automatically place a call to emergency services and provide the location of the car with GPS coordinates.

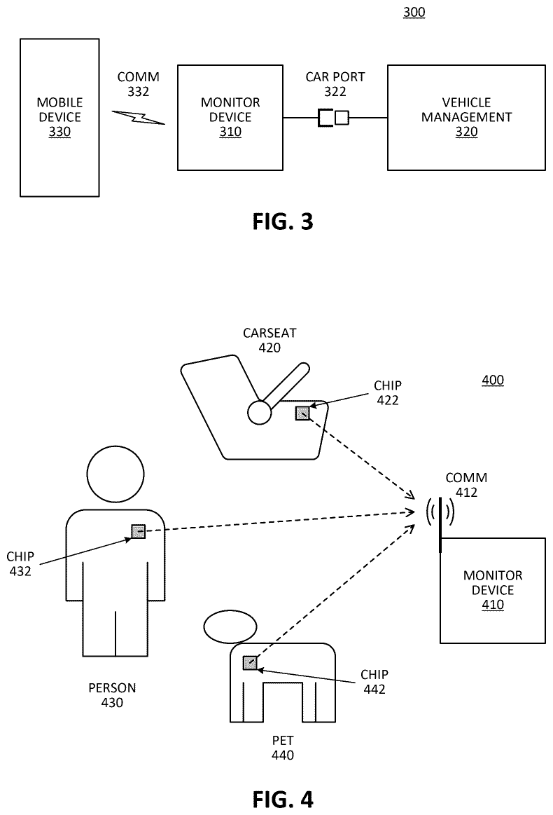

FIG. 3 is a block diagram of an example of a system for in-vehicle monitoring. System 300 illustrates a system in accordance with an example of system 100. Monitor device 310 illustrates a monitoring device in accordance with an example of system 200.

System 300 includes monitor device 310, which illustrates an in-vehicle monitoring system in accordance with any example herein. In one example, monitor device 310 plugs into car port 322, which represents a physical interconnection to vehicle management 320. In one example, monitor device 310 also has wireless communication, represented by COMM 332, to interconnect with mobile device 330.

System 300 does not specifically illustrate the sensors and monitoring equipment used to determine the presence of an unattended occupant. System 300 illustrates the interconnection of a standalone monitor device to the vehicle operating system. Vehicle management 320 represents the system that runs the vehicle operating system, whether in a vehicle computer or in an infotainment system. In an integrated implementation, the physical connection through car port 322 may be unnecessary.

As described elsewhere, monitor device 310 includes one or more monitoring capabilities, which can include wireless communication with occupant chips. COMM 332 represents the ability of monitor device 310 to communicate with a wireless device, such as a mobile phone or smartphone. Mobile device 330 represents a vehicle owner device that can be registered with monitor device 310. In response to an alert condition, in one example, monitor device 310 can send information to mobile device 330.

FIG. 4 is a block diagram of an example of an in-vehicle monitoring system that accesses identification chips. System 400 illustrates occupant monitoring for a monitor device in accordance with any example herein. Monitor device 410 represents any example of a monitor device herein.

In one example, monitor device 410 includes a wireless communication channel, represented by COMM 412. COMM 412 represents the ability of monitor device 410 to monitor for registered occupant chips. In one example, the system can detect a chip that is not registered and prompt the vehicle driver or vehicle owner whether to register the chip. Chips that are registered can be monitored by monitor device 410 for unattended occupant conditions.

Car seat 420 represents a child carrier or an animal carrier that is designed be occupied by a vehicle occupant. In one example, car seat 420 is chipped with chip 422. For example, chip 422 can be secured inside or outside car seat 420.

Person 430 represents a human occupant of a car, such as a child or a person with disabilities, or other non-operator occupant of the vehicle. Person 430 can wear chip 432, such as on a necklace, a bracelet, or an article of clothing.

Pet 440 represents an animal occupant of a car, which would also be a non-operator occupant of the vehicle. Pet 440 can wear chip 442, such as on a collar or a leash.

The vehicle owner or a vehicle operator (if different from the owner), can register one or more chips to be monitored by monitor device 410. In one example, when one or more chips are registered, monitor device 410 attempts to detect the chips when the vehicle is powered on. After detecting a chip that should be monitored (e.g., a registered chip), monitor device 410 can monitor for an unsafe condition for the occupant.

In one example, monitor device 410 detects whether the vehicle is turned off and the registered chip is still within the vehicle. In one example, monitor device 410 can monitor for a registered user's identifier, such as a key fob or a mobile device. In such an implementation, the monitor device can monitor to detect that the user's identifier device exits the vehicle after the vehicle stops moving, and the registered chip is still within the vehicle.

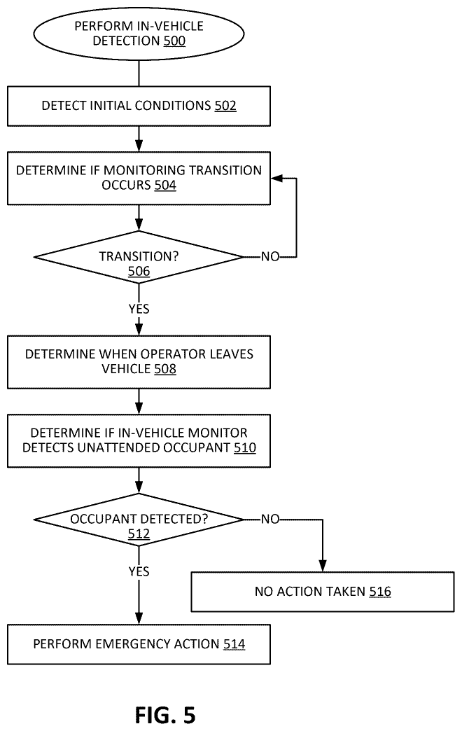

FIG. 5 is a flow diagram of an example of a process for performing in-vehicle monitoring. Process 500 represents a process for performing in-vehicle detection with a monitoring device in accordance with any example herein. Process 500 illustrates a simple example of when the system determines to alert the driver based on detection of an occupant in the vehicle with no driver.

In one example, the monitor device or the monitor system detects initial monitoring conditions, block 502. The initial conditions can include detection of a monitored chip and detection that the vehicle has been started. The initial conditions can differ depending on device operation and configuration. For example, a system that monitors an operator identifier (e.g., key fob, mobile phone) can detect such a device and a registered chip as an initial monitoring condition.

In one example, the monitor device monitors one or more conditions to determine if it should begin internal monitoring after the initial conditions are met, block 504. In one example, the device can detect that motion of the vehicle has stopped. In one example, the device can determine if the ignition has been turned off. It will be understood that the transition, such as from moving to stopped, from ignition on to ignition off, from driver door closed to open after one or more of the previous conditions, can indicate that the system should begin to monitor for conditions internally. In one example, the operator identifier device exiting the vehicle (e.g., as determined by determining signal strength) can be a transition condition. If the transition has not occurred, block 506 NO branch, the device can continue to monitor for the condition that indicates internal monitoring should begin.

If the transition condition for internal monitoring has occurred, block 506 YES branch, in one example, the in-vehicle monitor device first determines if the operator has left the vehicle, block 508. An occupant is not an unattended occupant unless and until the operator leaves the occupant unattended. Thus, the system can determine when the operator leaves the vehicle. In one example, the system determines the operator has left by accessing driver seat information (e.g., the sensor(s) that determine the operator is sitting in the driver's seat). In one example, the system determines the operator has left by monitoring a key fob or a mobile phone, although it will be understood that an operator can leave such articles behind, so they may be less reliable indicators. In one example, the system determines the operator has left by monitoring the vehicle for the doors being locked.

When the operator has left the vehicle, in one example, the in-vehicle monitor device determines if it detects an unattended occupant, in accordance with any description above, block 510. If no occupant is detected, block 512 NO branch, the system does not need to take any action, block 516.

If the vehicle is no longer being operated and the in-vehicle monitor detects an occupant in the vehicle, block 512 YES branch, the system can perform an emergency action, block 514, to alert any one of or combination of the vehicle operator, a bystander, and emergency services of the potentially unsafe condition.

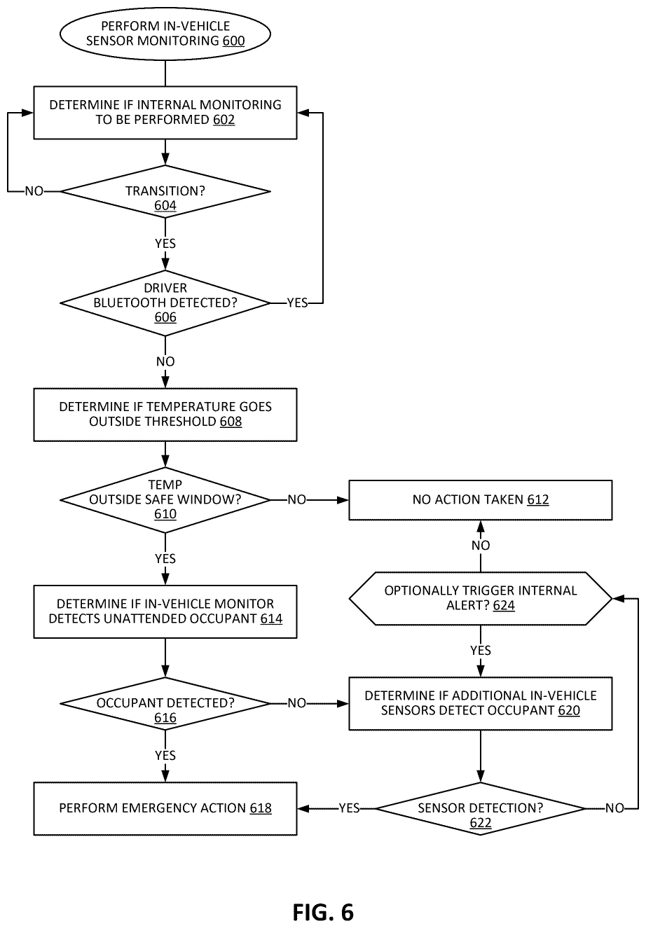

FIG. 6 is a flow diagram of an example of a process for performing in-vehicle sensing and monitoring. Process 600 represents a process for performing in-vehicle detection with a monitoring device with additional sensors in accordance with any example herein. Process 600 represents a more advanced decision-making process than what is described in reference to process 500.

In one scenario, a motion detector determines that the car is parked and not moving, a temperature sensor determines that the interior car temperature is reaching a threatening level, an NFC detector determines that there is a chipped pet or child in the car, and the system triggers the car horn to alert the driver as they exit the vehicle.

In one example, the system can determine if internal monitoring with in-vehicle sensors should be performed, block 602. In one example, to determine if in-vehicle monitoring should be performed, the system can determine if initial conditions are met and an initial monitoring condition transition has occurred. The transition can be a condition such as motion of the car stopping, the ignition turning off, a door opening then closing, or some other transition. If the transition, block 604 NO branch, the system can continue to determine if internal monitoring should be performed.

If the initial transition has occurred, block 604 YES branch, the system can optionally determine if a Bluetooth device (e.g., a mobile phone) associated with the driver can still be detected. If the Bluetooth device can still be detected, block 606 YES branch, the system can continue to monitor to determine if in-vehicle monitoring should be performed.

If the Bluetooth device cannot be detected, block 606 NO branch, the system can determine if the temperature goes outside a threshold, 608. If the temperature is within a window of temperatures configured as safe, block 610 NO branch, in one example, the system takes no action, block 612. If the temperature is outside a window of temperatures configured as safe, block 610 NO branch, in one example, the in-vehicle monitor determines if it can detect an unattended occupant, block 614.

If the system detects an occupant, block 616 YES branch, the system can perform an emergency action, block 618. The emergency action can be any type of action in response to detecting an unsafe condition, such as triggering an alarm or a car horn, alerting the driver or owner, alerting emergency services, or other action.

If the system does not detect an occupant, block 616 NO branch, additional in-vehicle sensors can determine if an occupant can be detected, block 620. If the additional sensors do not detect an occupant, block 622 NO branch, in one example, the system can optionally trigger an internal alert within the vehicle.

If the system determines to trigger an internal alert, block 624 YES branch, system can perform the internal alert and test the additional sensors again, block 620. The internal alert can be, for example, the playing of a high-pitch sound or some other alert to cause an occupant, if there is an occupant, to make a sound that the additional sensors can detect. If the system determines not to trigger the internal alert, block 624 NO branch, the system can determine to take no action, block 612.

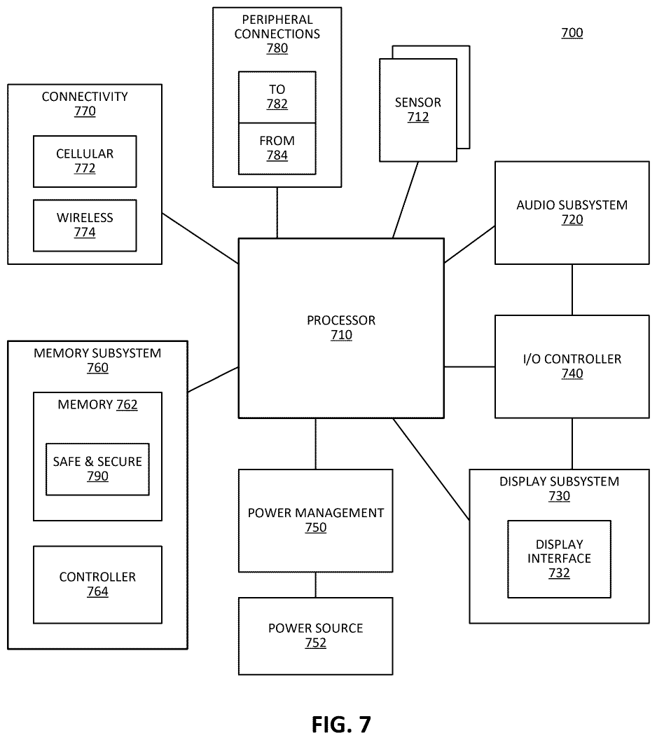

FIG. 7 is a block diagram of an example of a computer system to perform in-vehicle monitoring. System 700 represents a computing device in accordance with any example herein, and can be a standalone monitor device, a vehicle infotainment system, a vehicle management system, or other electronic device suitable for monitoring an in-vehicle condition. System 700 represents a system in accordance with an example of system 100 or system 200.

In one example, system 700 has one or more monitoring processes, represented by Safe & Secure 790. The operation of the monitoring processes can be in accordance with any monitoring system description herein. In one example, memory subsystem 760 stores information related to chips to be monitored, operator devices to track, or other information to enable the monitoring of conditions and the execution of an alert.

System 700 includes processor 710, which is a host processor device that performs the primary processing operations of system 700. Processor 710 can include one or more physical devices, such as microprocessors, application processors, microcontrollers, programmable logic devices, or other processing means. The processor can be a single core device or a multicore processor. The processing operations performed by processor 710 include the execution of an operating platform or operating system on which applications and device functions are executed. The processing operations include operations related to I/O (input/output) with a human user or with other devices, operations related to power management, operations related to connecting system 700 to another device, or a combination. The processing operations can also include operations related to audio I/O, display I/O, or other interfacing, or a combination. Processor 710 can execute data stored in memory. Processor 710 can write or edit data stored in memory.

In one example, system 700 includes one or more sensors 712. Sensors 712 represent embedded sensors or interfaces to external sensors, or a combination. Sensors 712 enable system 700 to monitor or detect one or more conditions of an environment or a device in which system 700 is implemented. Sensors 712 can include any sensors described herein.

In one example, system 700 includes audio subsystem 720, which represents hardware (e.g., audio hardware and audio circuits) and software (e.g., drivers, codecs) components associated with providing audio functions to the computing device.

Display subsystem 730 represents hardware (e.g., display devices) and software components (e.g., drivers) that provide a visual display for presentation to a user. In one example, the display includes tactile components or touchscreen elements for a user to interact with the computing device. Display subsystem 730 includes display interface 732, which includes the particular screen or hardware device used to provide a display to a user.

I/O controller 740 represents hardware devices and software components related to interaction with a user. I/O controller 740 can operate to manage hardware that is part of audio subsystem 720, or display subsystem 730, or both. Additionally, I/O controller 740 illustrates a connection point for additional devices that connect to system 700 through which a user might interact with the system.

In one example, system 700 includes power management 750 that manages battery power usage, charging of the battery, and features related to power saving operation. Power management 750 manages power from power source 752, which provides power to the components of system 700.

Memory subsystem 760 includes memory 762 (e.g., one or more memory devices) for storing information in system 700. Memory subsystem 760 can include nonvolatile (state does not change if power to the memory device is interrupted) or volatile (state is indeterminate if power to the memory device is interrupted) memory devices, or a combination. Memory 762 can store application data, user data, music, photos, documents, or other data, as well as system data (whether long-term or temporary) related to the execution of the applications and functions of system 700. In one example, memory subsystem 760 includes controller 764 (which could also be considered part of the control of system 700, and could potentially be considered part of processor 710).

Connectivity 770 includes hardware devices (e.g., wireless or wired connectors and communication hardware, or a combination of wired and wireless hardware) and software components (e.g., drivers, protocol stacks) to enable system 700 to communicate with external devices. Connectivity 770 can include multiple different types of connectivity. To generalize, system 700 is illustrated with cellular connectivity 772 and wireless connectivity 774. Cellular connectivity 772 refers generally to cellular network connectivity provided by wireless carriers. Wireless connectivity 774 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 780 include hardware interfaces and connectors, as well as software components (e.g., drivers, protocol stacks) to make peripheral connections. It will be understood that system 700 could both be a peripheral device (“to” 782) to other computing devices, as well as have peripheral devices (“from” 784) connected to it.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. An apparatus comprising:
a hardware interface to a wireless communication device to detect an RFID (radio frequency identification) chip; and
a processor in a vehicle, in response to detection of the RFID chip, to determine if the RFID chip indicates an unattended occupant in the vehicle, and in response to a determination that there is an unattended occupant in the vehicle, the processor is to trigger an emergency action.

2. The apparatus of claim 1, wherein the RFID chip comprises an RFID chip on an animal.

3. The apparatus of claim 1, wherein the RFID chip comprises an RFID chip on a person.

4. The apparatus of claim 1, wherein the RFID chip comprises an RFID chip on an occupant carrier.

5. The apparatus of claim 1, wherein the processor comprises a processor of an infotainment system of the vehicle.

6. The apparatus of claim 1, further comprising: a hardware interface to a physical port of the vehicle.

7. The apparatus of claim 6, wherein the physical port comprises an onboard diagnostics (OBD) port.

8. The apparatus of claim 6, wherein the processor comprises a processor of a standalone monitoring device.

9. The apparatus of claim 1, wherein the processor is to determine if there is an unsafe condition for the unattended occupant.

10. The apparatus of claim 9, wherein to determine the unsafe condition comprises the processor to determine if a temperature inside the vehicle is above a high threshold or below a low threshold.

11. The apparatus of claim 1, wherein the emergency action comprises triggering of a car horn of the vehicle.

12. The apparatus of claim 1, wherein the emergency action comprises triggering of a car alarm system of the vehicle.

13. The apparatus of claim 1, wherein the emergency action comprises sending of an alert to a vehicle owner.

14. An apparatus comprising:
a hardware interface to one or more sensors that detect a non-operator occupant of a vehicle; and
a processor in the vehicle, in response to detection of the non-operator occupant and to a determination that the vehicle has stopped moving, and in response to a determination that the non-operator occupant is an unattended occupant in the vehicle, the processor is to trigger an emergency action.

15. The apparatus of claim 14, wherein the one or more sensors comprise a sound sensor.

16. The apparatus of claim 14, wherein the one or more sensors comprises a motion sensor.

17. A method for monitoring a vehicle, comprising:
detecting a non-operator occupant of the vehicle;
detecting that the vehicle has stopped moving;
determining that the non-operator occupant is left unattended in the vehicle; and
in response to the determining, triggering an emergency action.

18. The method of claim 17, wherein detecting the non-operator occupant comprises detecting an RFID chip associated with the non-operator occupant, or detecting the non-operator occupant through a sensor.

19. The method of claim 17, wherein triggering the emergency action comprises triggering a car horn of the vehicle, triggering a car alarm system of the vehicle, or sending an alert to a vehicle operator.

20. The method of claim 17, further comprising: determining if there is an unsafe condition for the non-operator occupant, including determining if a temperature inside the vehicle is above a high threshold or below a low threshold.
